(19) United States
(12) Patent Application Publication
(10) Pub. No.: US 2017/0329450 A1
(43) Pub. Date: Nov. 16, 2017

(54) INPUT DEVICE WITH VERIFICATION OF TOUCH OR ACTIVATION

(71) Applicant: PREH GMBH, BAD NEUSTADT A. D. SAALE (DE)

(72) Inventors: MANUEL STOTZEM, WUELFERSHAUSEN (DE); FELIX KATZENBERGER, BAD KOENIGSHOFEN (DE); GORDON HEMANN, HOHENROTH (DE)

(73) Assignee: PREH GMBH, BAD NEUSTADT A. D. SAALE (DE)

(21) Appl. No.: 15/586,283

(22) Filed: May 4, 2017

(30) Foreign Application Priority Data
May 10, 2016 (DE) 10 2016 108 634.7

(51) Int. Cl. G06F 3/041; G06F 3/044; B60K 37/06; G06F 3/042

(52) U.S. Cl. CPC G06F 3/0416; G06F 3/042; G06F 3/044; B60K 37/06; B60K 2350/1028; B60K 2350/90; B60K 2350/928

(57) ABSTRACT

An input device includes an input surface, at least one first detector which detects a touch and/or an activation of the input surface, a second detector which includes a detection range which covers the input surface, and an evaluation unit. The second detector detects a no-touch of the input surface. The evaluation device assigns a switching or control function to the at least one of the touch and the activation of the input surface upon the detection of the at least one of the touch and the activation by the first detector. The evaluation unit excludes the assignment of the switching or control function upon detecting the no-touch by the second detector.

### CROSS REFERENCE TO PRIOR APPLICATIONS

Priority is claimed to German Patent Application No. DE 10 2016 108 634.7, filed May 10, 2016. The entire disclosure of said application is incorporated by reference herein.

### FIELD

The present invention relates to an input device defining at least one input surface.

A great number of input devices have previously been described, largely due to many different operating concepts. In practical application, input devices thus differ in their requirements concerning functional safety, hereinafter referred to as “functional safety”, resulting from the switching and control functions they must perform, and/or from their configuration. It is common, for example, that the requirements for an input device to operate a vehicle's speed control system are higher than for an input device controlling the comfort function of the vehicle.

### BACKGROUND

The configuration of an input device can also result in higher requirements, such as in an input device with several adjacent input surfaces, also called buttons, each of which can be part of a continuous surface. Even in such a case, it is always necessary to verify the operation or activation of an input surface to prevent operating errors. A particularly higher demand exists when both situations coincide, i.e., when the function to be controlled by the input device is safety-relevant and the activation or touching of the input device must be verified, for example, to suppress the triggering of the function through the unintentional touching or activation of the input device. The latter constellation can be of particular importance when several input surfaces are arranged in close proximity, rendering their contact surface relatively small and/or directly adjacent to each other or in the immediate vicinity of a gripping surface, for example, that of a steering wheel.

EP 2977872 A1 describes a touchpad in which two capacitive assemblies, each detecting a touch, are provided to increase operating safety. A no-touch is not detected.

### SUMMARY

An aspect of the present invention is to provide an input device with improved functional safety which has a simple design and which is space-efficient.

In an embodiment, the present invention provides an input device which includes an input surface, at least one first detector configured to detect at least one of a touch and an activation of the input surface, a second detector comprising a detection range which covers the input surface, the second detector being configured to detect a no-touch of the input surface, and an evaluation unit. The evaluation unit is configured so that, upon the detection of the at least one of the touch and the activation by the first detector, the evaluation device performs an assignment of a switching or control function to the at least one of the touch and the activation of the input surface, and when detecting the no-touch by the second detector, the evaluation unit excludes the assignment of the switching or control function.

### BRIEF DESCRIPTION OF THE DRAWINGS

The present invention is described in greater detail below on the basis of embodiments and of the drawings in which:

FIG. 1 shows a sectional view of an embodiment of an inventive input device;

FIG. 2 shows a sectional view of an embodiment of an evaluation unit;

FIG. 3 shows a top view of an embodiment of the input device; and

FIG. 4 shows a partial view of a steering wheel.

### DETAILED DESCRIPTION

The present invention relates to an input device defining at least one input surface. The input device according to the present invention comprises at least one first detector which is designed to detect the touch of the input surface and/or the activation of the input surface. The terms “touch” and “activation” are to be interpreted so that touching means the soft but not necessarily powerless contact or adjoining arrangement of an input means, such as an operator's finger or fingertip, to the input surface, while activation means the application of an input means such as an operator's finger or fingertip to the input surface with some activating force. The present invention is not limited to any particular kind of detector. The first detector can, for example, be one that is designed to detect only a touch, which hereinafter is referred to as the first touch detector.

The first detector is therefore designed to detect a touch, but is not designed to detect an activating force, i.e., the first detector is not able to detect a measure or a direction of the exerted force. A space-resolving or motion-resolving touch detection is not, however, to be excluded thereby. In an embodiment, the first detector can provide the detection using an optical process and/or a capacitive process to achieve space-resolving and motion-resolving detection.

The first detector an, for example, comprise a capacitive tactile sensor. A capacitive tactile sensor defines at least one measuring capacity that is detected when the tactile sensor touches the input surface. Each tactile sensor can, for example, be provided with an associated electrically-insulated electrode generating a measuring capacity.

The present invention provides an evaluation unit which is designed to assign a switching and/or a control function to the touch or activation of the input surface of the input device when the first detector detects that the input surface is being touched or activated. The present invention also provides that the input device can, for example, comprise a second detector whose detection range covers the input surface. The second detector is designed to detect at least one no-touch of the input surface. Detection of the no-touch is defined in the present invention to mean that the second detector is designed to detect a situation where no adjacent arrangement of any object on the input surface exists, i.e., the input surface is untouched, and in particular untouched by an input means such as the operator's finger on the input surface.

The present invention provides an evaluation device which is designed to exclude assignment of a switching or control function when the second detector detects a no-touch. This prevents a switching or control function from being triggered by the evaluation unit in a case when the first detector erroneously detects a presumed touch or a presumed activation. The functional safety of the input device is thereby improved.

The second detector can, for example, be designed to detect a no-touch optically, for example, via a camera. Optical detection can provide a comparatively reliable no-touch detection. The detection signal used by the second detector can, for example, be radiation in the visible spectral range, such as a wavelength range of 380 nm to 780 μm, or infrared radiation, such as in a wavelength range of 0.78 μm to 1000 μm.

In an embodiment of the present invention, the second detector can, for example, also be designed to detect a touch to the input surface, for example, optically. The second detector can, for example, use an optical reflection measurement method. In an embodiment, the second detector can, for example, be designed to perform a space-resolving optical touch detection. The second detector can, for example, be designed to differentiate between the touch of human skin and another kind of touch. The second detector can, for example, use light in the infrared A-range as a detection signal, such as a wavelength range of 0.78 μm to 1.4 μm. In case of radiating human skin, this provides a comparatively deep penetration depth and therefore a distinct degree of absorption. When the second detector performs the reflex measurement, the second detector can thus clearly distinguish between a touch of human skin to the input surface and another kind of touch.

In an embodiment of the present invention, the second detector can, for example, be designed to non-invasively detect the vital data of the operator, for example, to optically differentiate between a touch from an object and the touch from a human body part, and thus to qualify the touch of an object as a no-touch as defined in the present invention. The pulse can, for example, optically be detected by the second detector. This can, for example, be based on the process of photo plethysmography (PPG), where changes of the blood volume in the blood vessels are measured optically. The blood volume that changes with each heart cycle flowing through the arteries can be recorded and measured with PPG. The heart rhythmically discharges blood (systole) and fills again with blood (diastole). More blood flows through the artery during systole, and less during diastole. What is measured is the change in blood volume in the body part adjacent to the input surface, such as the fingertip. The change in blood volume can be measured by the second detector via the specific light absorption of the hemoglobin (a ferrous protein complex which binds oxygen to the red blood cells of mammals and which provides them with their red color).

In an embodiment of the present invention, the second detector can, for example, be provided with a transmitter to generate a detection signal and with at least one receiver to receive the detection signal, whereby the input surface defines a border surface for reflecting the detection signal in the direction of the receiver. The second detector can, for example, be designed to detect a no-touch based on the intensity of the detection signal reflecting on the border surface, and thus also on the degree of reflection. The second detector can, for example, be designed so that in the case of a no-touch, the intensity of the detection signal reflected on the border surface and the received signal is increased or reduced compared with the state in which a touch occurs, such as from a finger.

In an embodiment of the present invention, the input surface can, for example, be defined by a layer of material which is permeable for the detection signal, for example, a translucent material such as a transparent plastic or a glass material such as soda-lime glass, quartz glass, float glass, borosilicate glass, or flint glass.

In an embodiment of the present invention, the second detector can, for example, be provided with another receiver which is designed to receive the detection signal on the input service independently of a touch and independently of a no-touch. This enables the monitoring of a function of the transmitter of the second detector.

In an embodiment of the present invention, the detection signal can, for example be encoded to improve operating safety, for example, by analogous encoding such as via modulation, or by digital encoding.

In an embodiment of the present invention, several first detectors can, for example, be provided which are designed so that they detect a touch on the input surface or an activation of the input surface independently of each other. The evaluation unit can, for example, be designed so that during a common detection of a touch or activation by at least two of the detectors, a shifting or control function is assigned to the input device during activation or touch, if the second detector does not detect a no-touch. A sufficient coincidence in the detection signal can be understood in this sense as a common detection by at least two first detectors. In an embodiment, the at least two detectors are also designed differently, i.e., they differ in the physical operation of their detection and/or measuring systems.

In an embodiment of the input device with several first detectors, these can, for example, comprise at least one first detector which capacitively detects touch and one first detector which detects an activation, which comprises a power sensor activation force with an activation force acting capacitively or resistively upon the input surface.

The evaluation unit can, for example, be electrically connected with the at least one first detector and the second detector via data cables insulated against each other to transmit the associated detection result. According to the present invention, the signals of the detector are evaluated by the evaluation unit.

The present invention also relates to a steering wheel to which an input device according to one of the above described embodiments is attached. The input device can, for example, be a so-called multifunctional switch in the steering wheel.

The present invention also relates to the use of the input device in the form of one of the above-described embodiments in a motor vehicle, in particular to control a speed control system, which is also referred to as a “tempomat” or “cruise control”.

The process according to the present invention also comprises a step of detecting a touch and/or activation of the input surface by the first detector. The process according to the present invention also comprises a subsequent step of verifying the detection by the first detector by detection of the second detector in which the evaluation unit is designed to exclude the assignment of a shifting or control function by the second detector upon detection of a no-touch. This prevents the triggering of a shifting or control function by the evaluation unit in the case of an unintentional touching or activation. This generally improves the functional safety of the input device. This prevents a switching or control function being triggered by the evaluation unit in a case when the first detector erroneously detects a presumed touch or a presumed activation. The functional safety of the input device is thereby improved in total.

Reference is made to the above-described embodiments of the inventive input device with regard to other advantageous embodiments of the process according to the present invention.

The present invention is described in detail below under reference to the drawings. The drawings are thereby to be understood only as examples showing embodiments of the present invention.

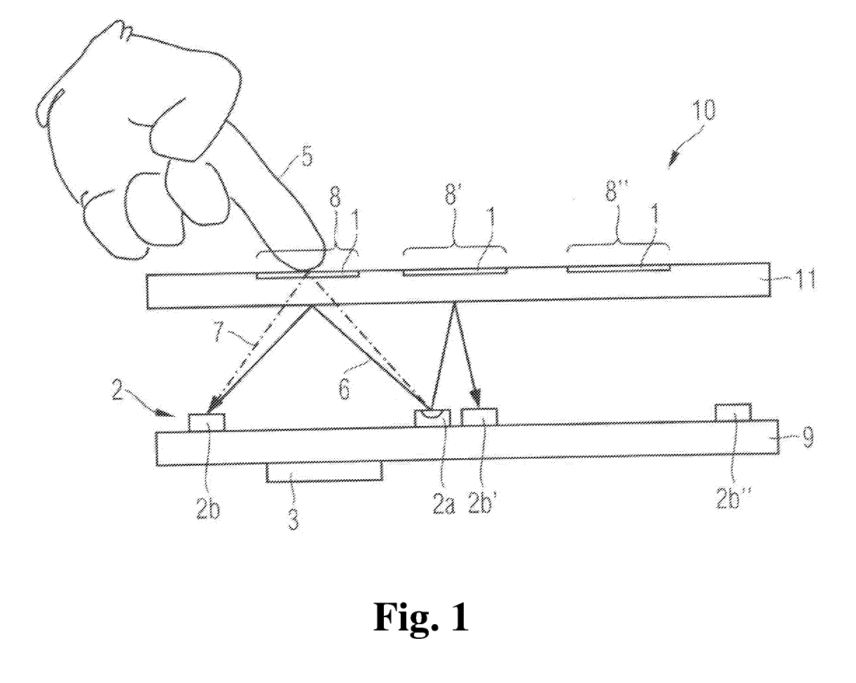

FIG. 1 shows a sectional view of a first embodiment of an inventive input device 10. This input device comprises a first detector 1, which is provided as several electrodes 1 arranged in an array. These electrodes 1 are embedded in a layer 11, or as shown on one of the surfaces of layer 11, on the surface of layer 11 facing the operator above an evaluation unit 3, the electrodes 1 each producing a measuring capacity based on electrical contact. The extent of electrode 1 approximately defines the spatial extent of an input surface 8. The variation of the measuring capacity, when touched by an operating organ 5 in the area of the input surface 8, is detected and evaluated by evaluation unit 3. When this variation exceeds a predetermined threshold value, an assigned switching function is triggered by evaluation unit 3 as long as the detection result detected by the first detector 1 does not conflict with a detection result of a second detector 2. The second detector 2 serves to optically detect a no-touch as well as to optically detect a touch in the area of input surface 8. Electrode 1 and layer 11, the layer 11 being at least in the area forming input surface 8, are made of a transparent or of a translucent material. The second detector 2 is provided with an infrared transmitter 2a to generate an infrared detection signal and with several infrared receivers 2b, 2′ and 2″ to receive the detection signal transmitted by the second detector 2, in this case the infrared light. The transmitter 2a and the receivers 2b, 2b′ and 2b″ are arranged on a joint circuit board 9 which is arranged at a distance from layer 11 and below layer 11, as seen from the operator. The detection signal transmitted by the infrared transmitter 2a from below in the direction of input surface 8 is indicated on the surface of layer 11 which faces the transmitter 2a of layer 11 by the geometrical radiation path 6, but is also reflected as indicated by radiation path 7 on the border layer defined by input surface 8. The latter degree of reflection, however, very much depends on whether or not there is contact in the area of input surface 8, especially by the operating organ 5, which is shown in FIG. 1 as a human finger. Based on the change in intensity due the change in the degree of reflection of the detection signal received by receiver 2b, in this case infrared light, the second detector 2 is able to differentiate at least qualitatively between a touch and a no-touch. The received detection result is used in the evaluation unit 3 to verify the detection result. The received detection result is used in evaluation unit 3 to verify the detection result of the first detector 1, i.e., at least in the case of detection of a touch by the first detector 1 with a subsequent detection of a no-touch by the second detector 2 to exclude an assignment to a switching and control function to prevent the triggering of the switching and control function due to a defective or incorrect detection of the first detector 1. The detection of a touch by the second detector 2 is furthermore used to confirm, i.e., to verify the detection result from a prior positive detection of a touch by the first detector 1. The minimum intensity that necessarily results from the reflection on layer 11 facing the transmitter 2a of the reflected and received detection signals, in this case infrared light, even without a touch of the input surface, and which is to be detected by receiver 2b, is also used to perform a functional control of the second detector 2, especially of the associated transmitter 2a. As shown in FIG. 1, the sketched embodiment of the inventive input device 10 is provided with further electrodes 1 and associated input surfaces 8′ and 8″ defined by these electrodes 1. Due to the comparatively broad radiation characteristics of transmitter 2a and its almost central arrangement, it is possible to generate (only by a single transmitter 2a) a second detection signal belonging to the second detector 2 which is enough to perform an independent touch detection or no-touch detection pertaining to the input surfaces 8, 8′ and 8″ via the associated receivers 2b′ and 2b″.

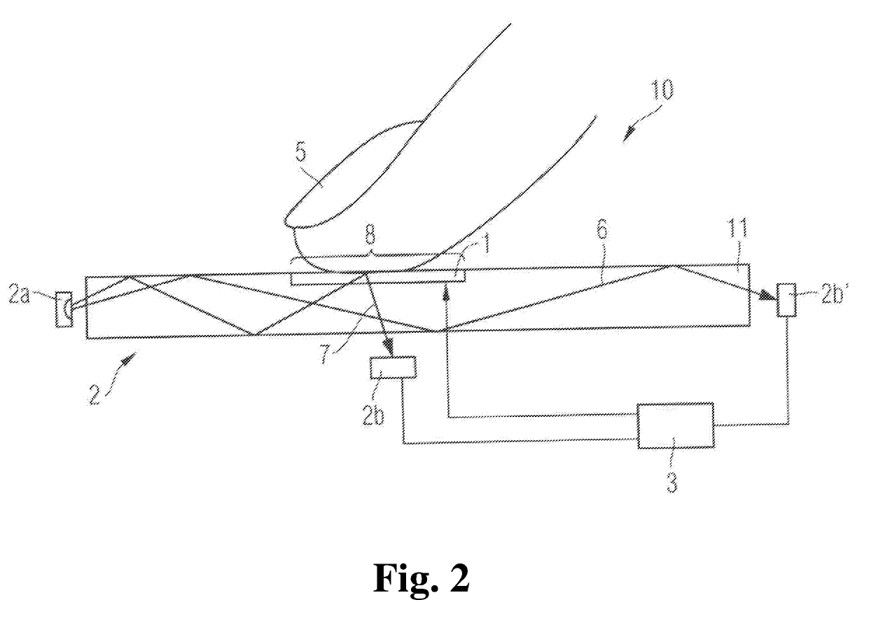

FIG. 2 shows a sectional view of a second embodiment of an inventive input device 10. This input device is provided with a first detector 1 which only comprises one electrode 1.

Electrode 1 is applied to a surface of a layer 11 facing the operator and is electrically contacted by an evaluation unit 3 to generate a measuring capacity. The extent of electrode 1 approximately defines the spatial extent of an input surface 8. The variation of this measuring capacity, when touched by an operating organ 5 in the area of input surface 8, is detected and evaluated by evaluation unit 3. When this variation exceeds a predetermined threshold value, evaluation unit 3 generates an associated switching function if the detection result detected by the first detector 1 does not conflict with a detection result of a second detector 2. The second detector 2 provides the optical detection of a no-touch as well as the optical detection of a touch in the area of input surface 8. The electrode 1 and layer 11 are made of a transparent material or of a translucent material. The second detector 2 comprises an infrared transmitter 2a to generate an infrared detection signal. In the shown embodiment, the infrared signal radiated by the infrared transmitter 2a is radiated laterally into the front surface of layer 11 facing away from the operator, as indicated by the geometrical radiation path 6 and radiation path 7, and due to total reflection permeates layer 11 to be received and detected by receiver 2b′ arranged on the opposite front side of layer 11, while a reflection also occurs at the border layer defined by input surface 8, as indicated by radiation path 7. The latter degree of reflection greatly depends on whether or not there is a touch in the area of input surface 8, especially by an operating organ 5, shown here as a human finger. Due to the change in intensity based on the change in the degree of reflection of the light received from receiver 2b, the second detector 2 is able to at least qualitatively differentiate between a touch and a no-touch. The received detection result is used in evaluation unit 3 to verify the detection result of the first detector 1, i.e., at least in the case of detecting a touch by the first detector 1 and a subsequent detection of a no-touch by the second detector 2 to prevent a switching or control function from being assigned due to a defective or incorrect detection by the first detector 1. The detection of a touch by the second detector 2 is furthermore used to conform or verify the result of the detection of a prior positive touch by the first detector 1. The permeation of the detection signal through layer 11 of transmitter 2a to the opposite receiver 2b′, and the minimum intensity of the reflecting and receiving detection signal, which also occurs without touch of input surface 8, is furthermore used to perform a functional control of the second detector 2, particularly of the associated transmitter 2a.

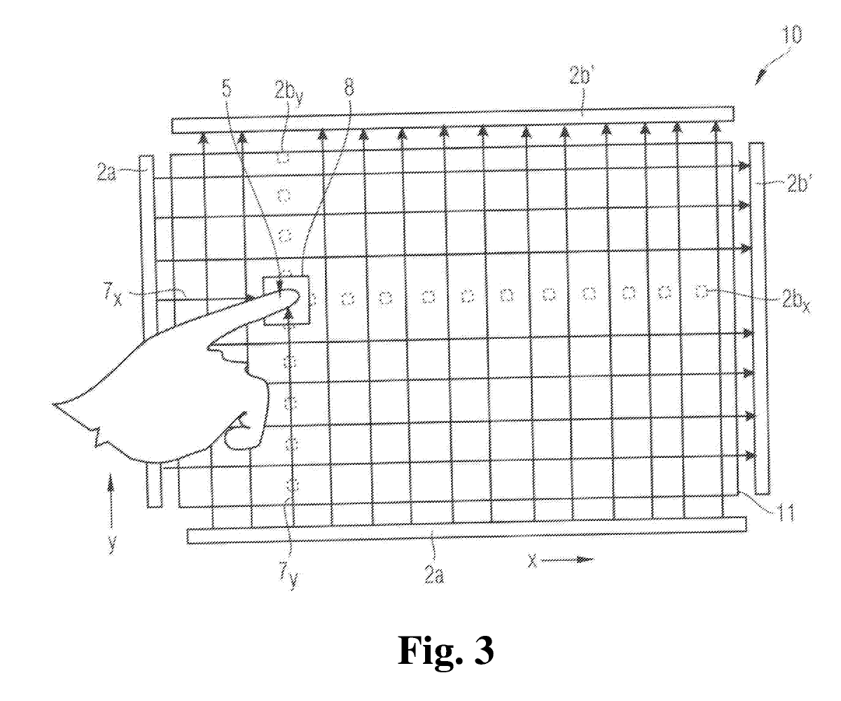

FIG. 3 shows a third embodiment of the inventive input device 10 where the second optically detecting detector is designed to perform a space-resolving no-touch detection and a space-resolving touch detection, thereby also allowing a functional control. The first detector is not shown for the sake of clarity. As with the embodiment shown in FIG. 2, radiation is radiated laterally into the transparent layer 11, whereby an array of transmitters 2a is arranged along the front surface of layer 11 in the X direction and another array of transmitters 2a is arranged along the front surface of layer 11 in the Y direction. As seen from the operator, an array of receivers 2bx and 2by are arranged which are only indicated in FIG. 3, and which are designed and arranged to receive the detection signal, which is reflected in case of a touch by an operating organ 5 (which is shown as finger) in the range of a specific input surface 8 from an array of input surfaces 8. The array of input surfaces 8 results from the arrangement of electrodes of the first detector 1 (which is not shown in detail in FIG. 3), whereby the extent and position of the individual input surfaces 8 is determined by the arrangement of the individual electrodes. Due to the touch-specific reflection of the detection signal with regard to specific receivers of the array of receivers 2bx and 2by, in addition to the qualitative touch detection, an input surface-specific spatial resolution is possible, as indicated by the two radiation paths 7x and 7y. An additional functional control of transmitters 2a is facilitated by the receivers 2b′ being arranged at the opposite front surface of layer 11, which can detect the detection signal that can permeate layer 11 due to total reflections, independently of any touch of the input surfaces 8.

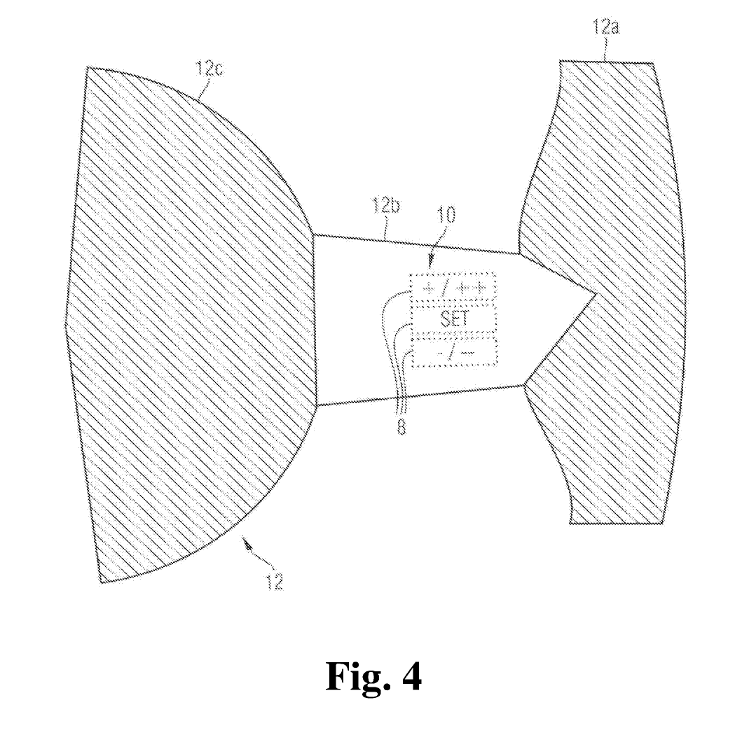

In a partial sectional view, FIG. 4 shows an inventive steering wheel 12 which comprises an outer steering wheel rim 12a defining a grip area, a hub 12c, and one or more spikes 12b connecting the above named components. In one of the inventive embodiments, on the side of the driver (not shown in FIG. 4), an input device is integrated in the steering wheel spike 12b. This input device 10 is for the functional input and control of a speed control system (not shown in FIG. 4). For this purpose, input device 10 has an array of three input surfaces 8 on the driver's side of steering wheel spike 12b, each having different assigned control functions. As described above, the present invention provides that at least one first detector and a second detector, whose inventive embodiments have been described above, are assigned to each of these input surfaces 8.

The present invention is not limited to embodiments described herein; reference should be had to the appended claims. Individual characteristics mentioned in the appended claims can thereby be combined in any technologically meaningful manner to constitute additional arrangements of the present invention. The description, especially with reference to the drawings, additionally characterizes and specifies the present invention.

What is claimed is:

1. An input device comprising:
an input surface;
at least one first detector configured to detect at least one of a touch and an activation of the input surface;
a second detector comprising a detection range which covers the input surface, the second detector being configured to detect a no-touch of the input surface; and
an evaluation unit configured so that,
upon the detection of the at least one of the touch and the activation by the first detector, the evaluation device performs an assignment of a switching or control function to the at least one of the touch and the activation of the input surface, and
when detecting the no-touch by the second detector, the evaluation unit excludes the assignment of the switching or control function.

2. The input device as recited in claim 1, wherein the second detector is configured to detect the no-touch optically.

3. The input device as recited in claim 1, wherein the second detector is configured to detect the no-touch via an optical reflection process.

4. The input device as recited in claim 1, wherein,
the second detector further comprises a transmitter which is configured to generate a detection signal and at least one receiver which is configured to receive the detection signal, and
the input surface defines a border surface configured to reflect the detection signal in a direction of the at least one receiver.

5. The input device as recited in claim 4, wherein the detection signal is encoded.

6. The input device as recited in claim 4, wherein the input surface is defined by a layer which comprises a material which is permeable for the detection signal.

7. The input device as recited in claim 6, wherein the material is a translucent material.

8. The input device as recited in claim 4, wherein the second detector is further configured to receive the detection signal independently of the touch and independently of the no-touch of the input surface.

9. The input device as recited in claim 1, wherein at least one of the at least one first detector and the second detector are further configured to perform at least one of a space-resolving touch detection and a motion-resolving touch detection.

10. The input device as recited in claim 1, wherein the at least one first detector is provided as a plurality of first detectors, the plurality of first detectors being provided as at least one capacitive touch detection device and at least one activation detection device, the at least one capacitive touch detection device and the at least one activation detection device comprising a force sensor which is configured to act upon the input surface capacitively, resistively, or piezo-electrically.

11. A steering wheel comprising the input device as recited in claim 1 fastened to the steering wheel.

12. A method of using the input device as recited in claim 1 in a motor vehicle, the method comprising:
providing the input device as recited in claim 1 in a motor vehicle; and
using the input device to control a speed control system of the motor vehicle.

13. A process for an input verification, the process comprising:
providing an input device comprising,
an input surface,
at least one first detector configured to detect at least one of a touch and an activation of the input surface,
a second detector comprising a detection range which covers the input surface, the second detector being configured to detect a no-touch of the input surface, and
an evaluation unit configured so that,
upon a detection of the at least one of the touch and the activation by the first detector, the evaluation device performs an assignment of a switching or control function to the at least one of the touch and the activation of the input surface, and
when detecting the no-touch by the second detector, the evaluation unit excludes the assignment of the switching or control function;
detecting at least one of the touch and the activation of the input surface by the first detector;
verifying the detection of at least one of the touch and the activation of the input surface by the first detector via the detection by the second detector; and, if the no touch is detected by the second detector,
excluding the assignment of the switching or control function by the evaluation unit.
